(19) United States
(12) Patent Application Publication
(10) Pub. No.: US 2015/0172332 A1
(43) Pub. Date: Jun. 18, 2015

(54) PERSONALIZING SHARED COLLABORATION CONTENT

(71) Applicants: Eyal Roth, Yehud (IL); Olga Tubman, Rishon Le-Tzion (IL); Kobi Eisenberg, Yehud (IL)

(72) Inventors: Eyal Roth, Yehud (IL); Olga Tubman, Rishon Le-Tzion (IL); Kobi Eisenberg, Yehud (IL)

(21) Appl. No.: 14/406,609

(22) PCT Filed: Jun. 29, 2012
(86) PCT No.: PCT/US2012/044864

§ 371 Date: Dec. 9, 2014

(51) Int. Cl. H04L 29/06; G06F 3/0484

(52) U.S. Cl. CPC H04L 65/403; G06F 3/0484

(57) ABSTRACT

A method for providing personalized displays of shared collaboration content includes associating a collaborative experience with an application, a first participant, a second participant, a first element, and a second element. For the first participant, a display of first collaboration content is caused. The first collaboration content including a timeline for the collaborative experience and the first element but not the second element. For the second participant, a display of second collaboration content is caused. The second collaboration content includes the timeline for the collaborative experience and the second element but not the first element.

### BACKGROUND

Collaboration tools such as e-mail and chat enable participants to engage in conversations and collaborate on a variety of issues. The context of such conversations is discerned by the participants reading the conversation. Initially, the context may be defined by a subject line. All participants view the same information, that is, the same collaboration content. As the e-mail or chat thread grows with static files being added as attachments, the current topic of discussion evolves over time. As a result, new and existing participants can find it cumbersome to discern the current context making it more difficult to take actions called for by the conversation.

### DRAWINGS

FIGS. 1-4 depict screen views of user interfaced presenting collaboration content according to an example.

FIG. 5 depicts an environment in which various embodiments may be implemented.

FIG. 6 depicts a system according to an example.

FIG. 7 is a block diagram depicting a memory resource and a processing resource according to an example.

FIG. 8 is a flow diagram depicting steps taken to implement an example.

### DETAILED DESCRIPTION

### Introduction

Enterprise software applications can be complex requiring significant training and knowhow for users to extract relevant information or perform specific actions of a given workflow. This is especially true where a workflow extends across applications and organizational silos. The information that a user consumes and the actions that are performed are often dynamic and defined by the context of that workflow. Before an action is taken, a user may collaborate with others to obtain perspective, guidance, or even permission.

Various embodiments described below were developed to allow individuals, referred to herein as participants, to collaborate on an evolving topic in the context of an application. As used herein, each such collaboration is referred to as a collaborative experience. Each participant is presented with collaboration content that includes a timeline of the collaborative experience (an experience timeline) along with elements personalized for each participant. As will be explained in more detail, the personalization allows each participant to more efficiently and effectively participate in the collaborative experience.

An experience timeline can include a series of posts. Posts represent comments or questions from the participants as well as actions taken by or on behalf of the participants. Personalized elements can, for example, include facets of the associated application or applications, recommendations related to the collaborative experience, and annotations. A facet is a user interface element used to present information from an associated application or applications and can also be used by a participant to interact with that application. A recommendation is data suggesting something to a participant. Such can include a suggestion to add a particular participant to the collaborative experience. Another can include a suggestion to review a related collaborative experience. An annotation is private information for a participant and, for example, can include a private post to the timeline, comments on a post, a reminder, or any other information.

Because the roles and responsibilities of the participants differ from one another, participants are often interested in different aspects of the collaborative experience. As a consequence, the collaboration content presented is personalized for each participant. While each participant may view the same experience timeline, each participant may be presented with elements that have been individualized for that participant. For example, annotations, recommendations, and a given application's facets may be selected based on the participant's role and past interactions with that application. This personalization allows each participant to more efficiently consume the collaboration content and effectively join in the corresponding collaborative experience.

The following description is broken into sections. The first, labeled “Illustrative Example,” presents an example in which collaborative content is personalized and presented to participants in a collaborative experience. The second section, labeled “Environment,” describes an environment in which various embodiments may be implemented. The third section, labeled “Components,” describes examples of various physical and logical components for implementing various embodiments. The fourth section, labeled as “Operation,” describes steps taken to implement various embodiments.

### Illustrative Example

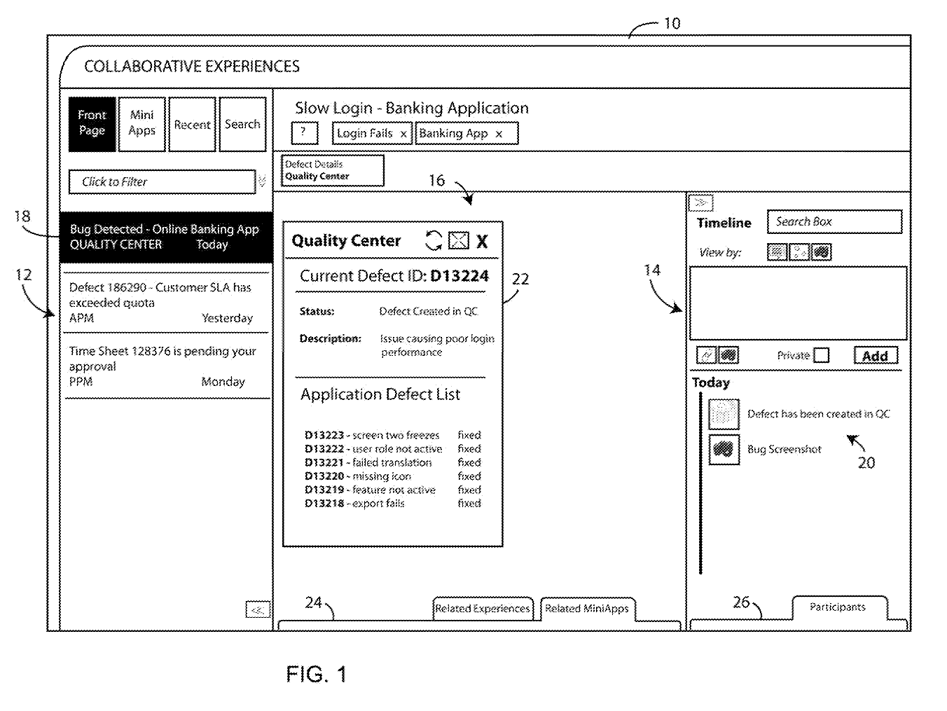

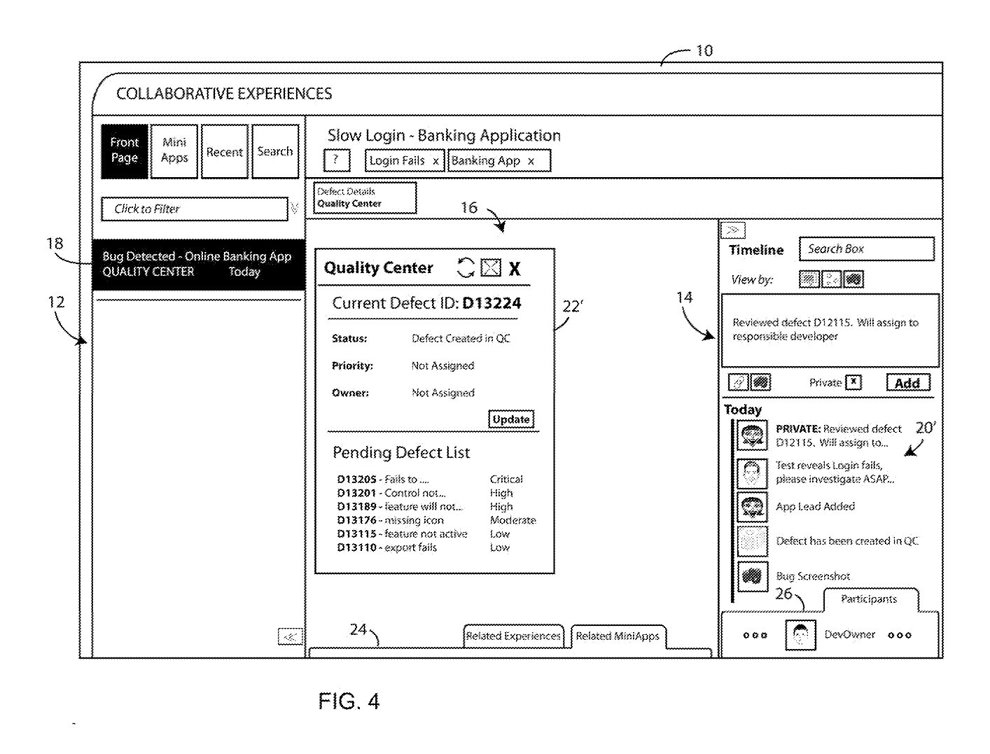

FIGS. 1-4 depict screen views of user interfaces used to display shared collaboration content personalized for different participants. A participant, as used herein, is an individual that has started, joined, is joining, or has been invited or otherwise added to a collaborative experience. FIGS. 1-3 are versions of the user interface personalized for and presented to a first participant. FIG. 4 is a version of the user interface personalized for and presented to a second participant of that same collaborative experience.

Starting with FIG. 1, presume that the first participant has entered a defect in a bug reporting system and has started a collaborative experience concerning that defect in a collaboration tool. FIG. 1 depicts a screen view 10 of a user interface of that collaboration tool. In this example screen view 10 is divided into three main sections 12, 14, and 16. Section 12 provides an area to display a list of collaborative experiences the particular participant is associated with. Here, experience 18 concerning the defect is highlighted, and, as a result, collaboration content for that collaborative experience is displayed in sections 14 and 16. Section 14 displays an experience timeline 20 while section 16 displays a facet 22 of the bug reporting tool.

In FIG. 1 experience timeline 20 is shown to include two elements defining activity to date for the experience. The first element indicate that a screenshot was recorded depicting the defect at issue and the second element indicates that a defect has been created in the bug reporting tool. Facet 22 depicts information from the bug reporting tool relevant to the participant viewing the collaborative content. Here that participant is the person who entered the defect in the bug reporting tool. The information presented includes the status and a description of the new defect as well as a list of other defects entered by the participant. The, the participant is presented with a personalized facet 22 with information directly relevant to the participant. FIG. 1 also includes recommendation tabs 24 and 24. Briefly, recommendation tabs 24 and 26 can be utilized to view relevant recommendations personalized for the given participant.

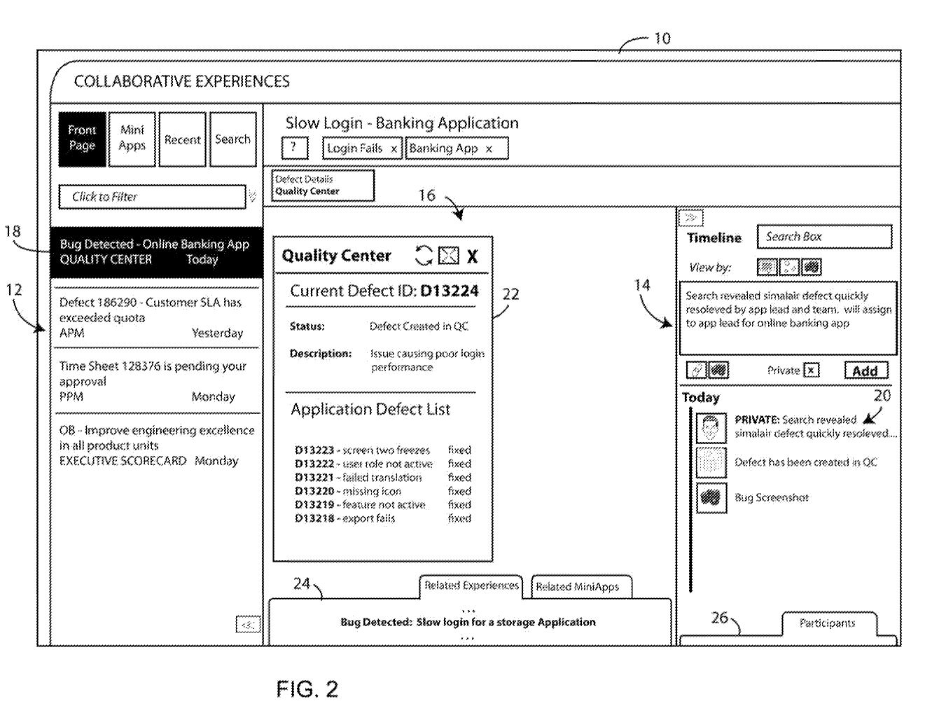

Looking at FIG. 2, the participant has selected related experiences tab 24 leading to the display of information concerning a related collaborative experience the participant can examine. In this example, the related experience deals with a different application defect determined to be similar to the defect at hand. This determination may, for example, have been made based on the participant's role or past interactions with the bug reporting tool. In other words, the participant is presented with a personalized recommendation of a similar collaborative experience that can be reviewed to provide insight as how to best handle the current defect. Continuing, the participant reviewed the recommended experience, gained some insight, and added a private comment to experience timeline 20. While, as shown below in FIG. 4, the experience timeline 20 is share with other participants, the timeline 20 can be personalized to include private annotations remain for a given participant.

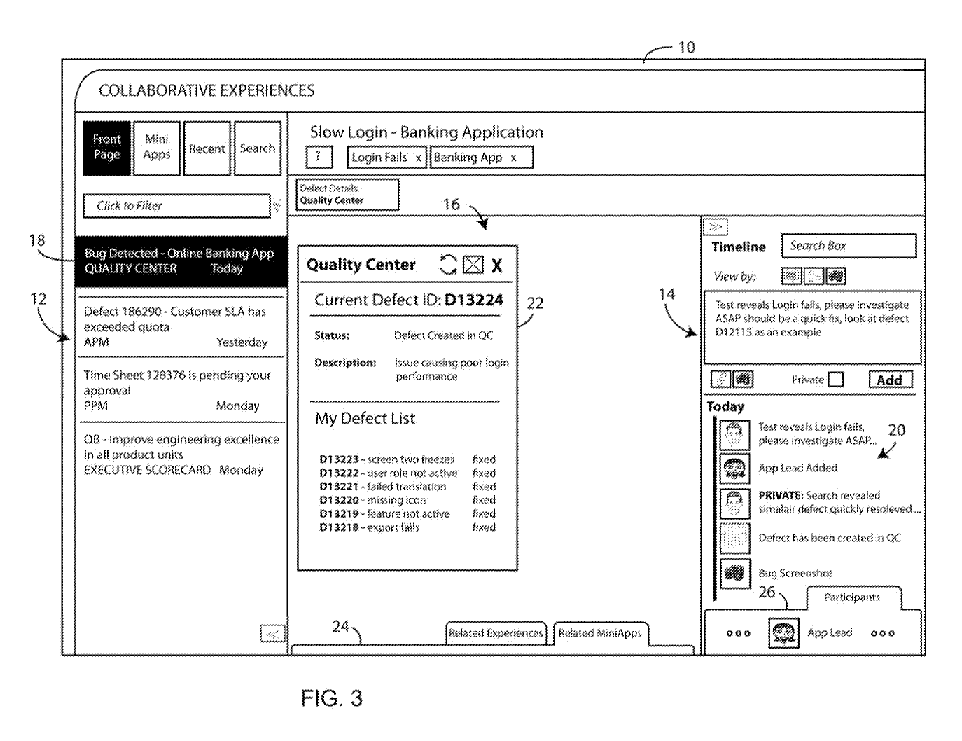

Jumping to FIG. 3, the participant has selected participants tab 26 leading to the display of suggested participants to add to the collaborative experience. This recommendation may be made based upon a number of factors including the participant's role and interactions with the application. Other factors can include the nature or context of the collaborative experience such as the particular application experiencing the defect and the relation of other users of that application to the current participant. Continuing, a suggest participant (App Lead) has been added as evidenced in the updated experience timeline 20. The current participant has also added a comment and instructions for newly added participant.

Looking now at FIG. 4, collaborative content is being presented for the newly added participant. Here, the new participant is presented with facet 22′ which, while presenting data from the same bug reporting tool, differs from facet 22 presented to the participant in FIGS. 1-3. Facet 22′ has been personalized for the new participant. Facet 22′ includes a list of pending defects and their priorities as well as data concerning the defect at hand and a control element to assign the defect to a software engineer. Experience timeline 20′ differs from timeline 20 of FIGS. 1-3 as it does not include private annotations from other participants. It only includes private annotations added by the current participant. Further, tab 26 shows differing participant recommendations than shown for the other participant. The recommendation here, for example, may be a for a software engineer that can remedy the defect.

To summarize, FIGS. 1-3 depict collaboration content personalized for a first participant to a collaborative experience. FIG. 4 depicts collaboration content for the same experience that has been personalized for a second participant. The personalizations allow each participant to more effectively engage and contribute to the collaborative experience.

Environment:

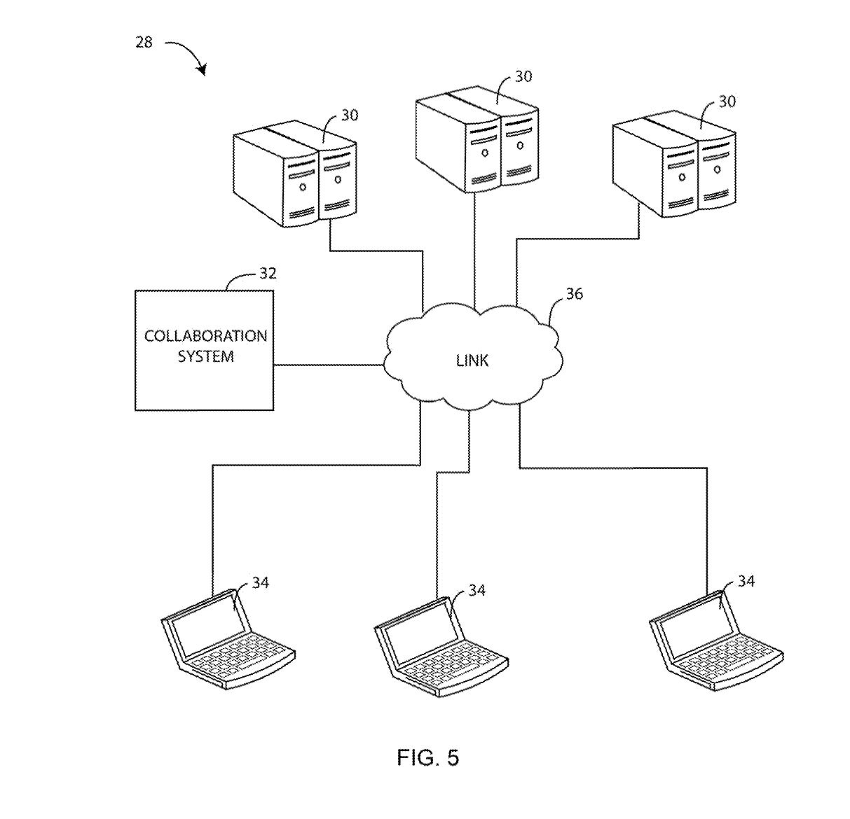

FIG. 5 depicts an environment 28 in which various embodiments may be implemented. Environment 28 is shown to include application services 30, collaboration system 32, and client devices 34. Application services 30 each represent a computing device or combination of computing devices configured to serve an application to client devices 34. Examples can include enterprise and consumer web and cloud applications provided through service oriented architectures.

Collaboration system 32 represents a computing device or combination of computing devices configured to serve a collaboration application to client devices 34. The collaboration application allows users to view and post to timelines of collaborative experiences in the context of applications served by services 30. In general, collaboration system 32 is responsible for presenting personalized collaboration content for each participant of a given collaborative experience.

Client devices 50 each represent a computing device configured to interact with application services 30 and collaboration system 32. Such interaction may be through a browser or other application executing on a given client device 34. Link 36 represents generally one or more of a cable, wireless, fiber optic, or remote connections via a telecommunication link, an infrared link, a radio frequency link, or any other connectors or systems that provide electronic communication. Link 36 may include, at least in part, an intranet, the Internet, or a combination of both. Link 36 may also include intermediate proxies, routers, switches, load balancers, and the like.

Components:

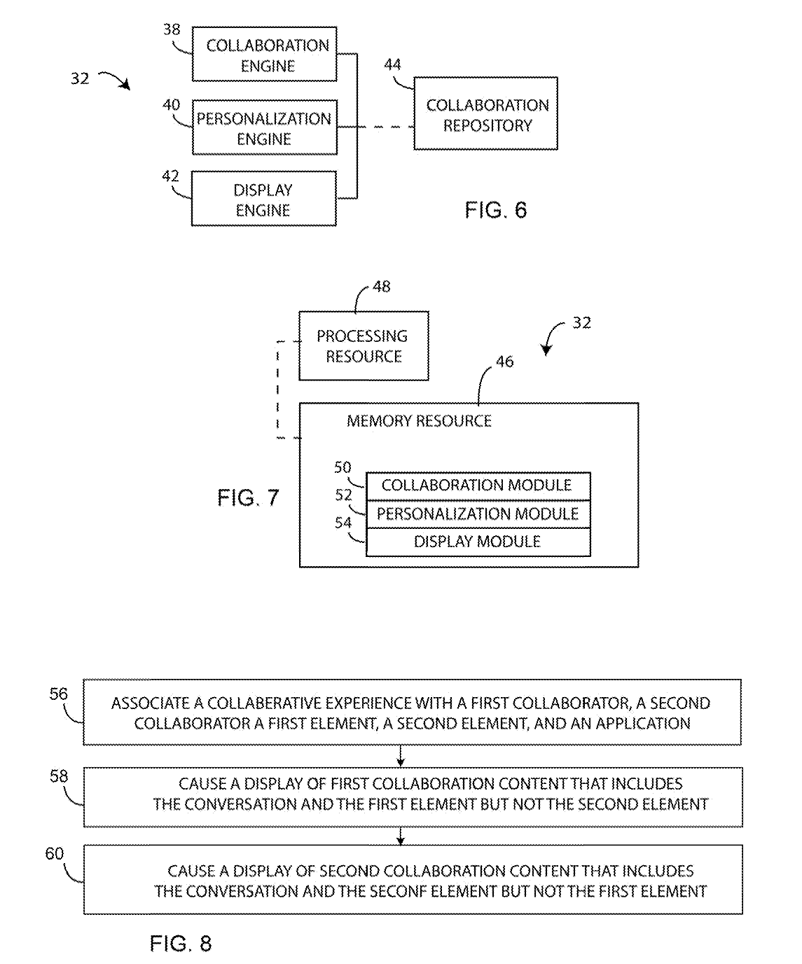

FIGS. 6 and 7 depict examples of physical and logical components for implementing various embodiments. FIG. 6 depicts collaboration system 32 for presenting personalized collaboration content. In the example of FIG. 6, system 32 includes collaboration engine 38, personalization engine 40, and display engine 42. Collaboration repository 44 represents memory configured to store data utilized by collaboration system 32. Such data can include a repository of collaborative experiences, data indicative of the roles of various participants as well as information indicative of each participant's past interactions with collaboration system 32 and the applications that are subjects of current, past, and future collaborative experiences.

Collaboration engine 38 represents generally any combination of hardware and programming configured to maintain data representing a collaborative experience between a first participant and a second participant. The collaborative experience is related to an application. The data, for example, can be maintained as part of collaboration repository 44. Maintaining the data can include generating, updating, and accessing the contents of collaboration repository 44. For example, collaboration engine 38 maintains data that associates the collaborative experience with its participants, applications, and its experience timeline.

The following is an example of a table characterizing the structure of the data maintained by collaboration engine 38.

| Experience ID | Application(s) | Participants | Timeline |
|---|---|---|---|
| Experience (1) | App(s) (1) | Names (1) | TL Data (1) |
| Experience (2) | App(s) (2) | Names (2) | TL Data (2) |
| . . . | . . . | . . . | . . . |
| Experience (n) | App(s) (n) | Names (n) | TL Data (n) |

In this fashion, each collaborative experience is associated with one or more applications, its participants, and data defining its timeline. In maintaining the data representing the experience timeline, collaboration engine 38 can also be said to maintain the experience timeline for each collaborative expedience. Such maintenance can include the creation of a timeline, the addition of posts to the timeline based on participant or application input, as well as deletion or modification of existing posts.

Personalization engine 40 represents generally any combination of hardware and programming configured to identify a first element corresponding to the first participant and a second element corresponding to the second participant. The elements are of the same category but are personalized in that the second element differs from the first element. As example, the first and second elements may be:
different facets of the same application;
different recommendations for adding participants or for reviewing related collaborative experiences; or
different annotations for the experience timeline.
   Thus, the element selected for the first participant can include any of a first facet, a first recommendation and a first annotation. The element selected for the second participant then includes any of a second facet (but not the first facet), a second recommendation (but not the first recommendation) and a second annotation (but not the first annotation).

Personalization engine 40 may identify each element based on one or more of a role of a given participant and a past interaction of that participant with one or more of collaboration system 32 and the applications associated with the collaborative experience. For example, personalization engine 40 may also maintain or have access to data associating particular role with particular facets. In such a case, personalization engine 40 may select an element by selecting a facet for a given participant based on the participant's role. Facet selection may be further personalized based on past actions of the participant. Historically, the given participant, when interacting with the application, may have primarily accessed a subset of the information available from that application. Or, the participant when interacting with a facet of the application in other collaborative experiences may have focused or drilled down to the particular subset of available information. Thus, the facet personalized for that participant may focus on such a subset of information.

Where a selected element includes a recommendation, personalization engine 40 may again rely on the participant's role or past interactions with collaboration system 32. Historically, when collaborating on a similar experience, the participant (or others in the same role) may have collaborated with a particular participant or a participant having a particular role. Thus, personalization engine 40 may select an element in the form of a recommendation, where that recommendation is personalized based on the participant's role and past interactions with collaboration system 32.

Where a selected element includes an annotation, personalization engine 40, again, can rely on the participant's role or past interactions with collaboration system 32. Historically, within the same collaborative experience, the participant may have annotated the experience timeline by adding a private annotation. Personalization engine 40 may select an element in the form of an annotation based on that prior interaction. Moreover, annotations may be selected based on the participant's role. For example, an experience timeline may include a post indicating that a particular event has occurred. Personalization engine 40 may maintain an association of event types and roles such that when an event of a given type is posted, it is flagged or otherwise annotated for a participant having an associated role.

Personalization engine 40 may be responsible for associating the elements it identifies with the corresponding collaboration experience. As an example, personalization engine 40 may update the table from above as follows.

| Experience ID | Application(s) | Participants | Timeline | Elements |
|---|---|---|---|---|
| Experience | Apps(s) (1) | Names (1) | TL Data (1) | F(1), R(1), |
| (1) | | | | A(1) |
| Experience | Apps(s) (2) | Names (2) | TL Data (2) | F(2), R(2), |
| (2) | | | | A(2) |
| . . . | . . . | . . . | . . . | . . . |
| Experience | Apps(s) (n) | Names (n) | TL Data (n) | F(n), R(n), |
| (n) | | | | A(n) |

F, R, and A each respectfully represent facets, recommendations, and annotations associated with a given collaborative experience. In this fashion, each collaborative experience is associated with data defining an experience timeline, an application, its participants, and elements personalized for those participants.

Display engine 42 represents any combination of hardware and programming configured to cause a display of first collaboration content for the first participant and second collaboration content for the second participant. The first collaboration content includes the experience timeline for the give collaborative experience and a first element personalized for the first participant. The first collaboration content, however, does not include a second element personalized for a second participant of the collaborative experience. The second collaboration content includes the experience timeline for the collaborative experience and the second element personalized for the second participant. The second collaboration content does not, however, include the first element. In this fashion, each participant is presented with personalized collaboration content that differs from that which is presented to the other.

Display engine 42 may cause a display in a number of fashions. In one example, display engine may directly control a display device directing it to display the collaboration content. In another example, display engine 42 may simply communicate the collaboration content with the expectation that a device ultimately receiving that communication will direct a display device to display the collaboration content.

In foregoing discussion, various components were described as combinations of hardware and programming. Such components may be implemented in a number of fashions. Looking at FIG. 7, the programming may be processor executable instructions stored on tangible memory resource 46 and the hardware may include processing resource 48 for executing those instructions. Thus memory resource 46 can be said to store program instructions that when executed by processor resource 48 implement collaboration system 32 of FIG. 7.

Memory resource 46 represents generally any number of memory components capable of storing instructions that can be executed by processing resource. Memory resource may be interceded in a single device or distributed across devices. Likewise processing resource represents any number of processors capable of executing instructions stored by memory resource. Processor resource may be integrated in a single device or distributed across devices. Further, memory resource 46 may be fully or partially integrated in the same device as processor resource 48 or it may be separate but accessible to that device and processor resource 48.

In one example, the program instructions can be part of an installation package that when installed can be executed by processing resource 48 to implement collaboration system 32. In this case, memory resource 46 may be a portable medium such as a CD, DVD, or flash drive or a memory maintained by a server from which the installation package can be downloaded and installed. In another example, the program instructions may be part of an application or applications already installed. Here, memory resource 46 can include integrated memory such as a hard drive, solid state drive, or the like.

In FIG. 7, the executable program instructions stored in memory resource 46 are depicted as collaboration module 50, personalization module 52, and display module 54. Collaboration module 50 represents program instructions that when executed cause processing resource 48 to implement collaboration engine 38 of FIG. 6. Personalization module 52 represents program instructions that when executed cause the implementation of personalization engine 40. Likewise, display module 54 represents program instructions that when executed cause the implementation of display engine 42.

Operation:

FIG. 8 is a flow diagram of steps taken to implement a method for providing personalized displays of shared collaboration content. In discussing FIG. 8, reference may be made to the screen views of FIGS. 1-4 and components depicted in FIGS. 5-7. Such reference is made to provide contextual examples only and not to limit the manner in which the method depicted by FIG. 8 may be implemented.

Initially, a collaborative experience is associated with an application, a first participant, a second participant, a first element, and a second element (step 56). Referring to FIG. 6 as an example, collaboration engine 38 and personalization engine 40 may work together to implement step 56. Collaboration engine 38 may initially associate a collaborative experience with the application and the participants storing the associations in collaboration repository 44. Personalization engine 40 may then associate the collaborative experience with the first and second elements by updating the associations in collaboration repository 44.

Associating in step 56 can include associating the collaborative experience with the first and second elements based on one or more of the roles of the first and second participants and past interactions of the participants. The roles, for example, are the participants' roles within a given organization. The past interactions are interactions with one or more of the collaboration system responsible for managing collaborative experiences and the application associated with the given collaborative experience. The first element can includes one or more of a first facet of the application, a first recommendation, and a first annotation. The second element can then include one or more of a second facet of the application but not the first facet, a second recommendation but not the first recommendation, and a second annotation but not the first annotation.

Thus, the method depicted in FIG. 7 can include identifying roles of the first and second participants then selecting a first facet of the application based on the identified role of the first participant and selecting a second facet based on the identified role of the second participant. Step 56 can then include associating the collaborative experience with the first element which includes the first facet but not the second facet. Step 56 can then also include associating the collaborative experience with the second element which included the second facet but not the first facet.

The method depicted in FIG. 7 can also include identifying a prior interaction of the first participant and the application and a prior interaction of the second participant with the application. Further, a first facet of the application can be selected based on the identified interaction of the first participant. A second facet can be selected based on the identified interaction of the second participant. Again, step 56 can then include associating the collaborative experience with the first element which includes the first facet but not the second facet and associating the collaborative experience with the second element which included the second facet but not the first facet.

With the associations established in step 56, first collaboration content is caused to be displayed for the first participant (step 58). Second collaboration content is caused to be displayed for the second participant (step 60). The first collaboration content includes a timeline for the collaborative experience and the first element but not the second element, while the second collaboration content includes the timeline and the second element but not the first element. Referring to FIG. 6, display engine 42 may be responsible for implementing steps 58 and 60. In doing so display engine may access collaboration repository 44 to identify and access the first element when causing the display for the first participant. Likewise, display engine 42 would access the second element when causing the display for the second participant. Referring to FIGS. 1-4, the screen views of FIGS. 1-3 each represent an example of the display of collaboration content the first participant caused in step 58, while the screen view of FIG. 4 represents an example for step 60.

### CONCLUSION

FIGS. 1-4 depict example screen views of various user interfaces. The particular layouts and designs of those user interfaces are examples only and intended to depict a sample workflow in which personalized collaboration content is presented to different participants of a collaborative experience. FIGS. 5-7 aid in depicting the architecture, functionality, and operation of various embodiments. In particular, FIGS. 6 and 7 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any non-transitory computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any non-transitory media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagram of FIG. 8 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method, implemented by a collaboration system, for providing personalized displays of shared collaboration content, comprising:
associating a collaborative experience with an application, a first participant, a second participant, a first element, and a second element;
for the first participant, causing a display of first collaboration content, the first collaboration content including a timeline for the collaborative experience and the first element but not the second element; and
for the second participant, causing a display of second collaboration content, the second collaboration content including the timeline for the collaborative experience and the second element but not the first element.

2. The method of claim 1, where associating comprises:
associating the collaborative experience with the first element based on one or more of a role of the first participant and a past interaction of the first participant with one or more of the collaboration system and the application; and
associating the collaborative experience with the second element based on one or more of a role of the second participant and a past interaction of the second participant with one or more of the collaboration system and the application.

3. The method of claim 2, wherein:
the first element includes one or more of a first facet of the application, a first recommendation, and a first annotation; and
the second element includes one or more of a second facet of the application but not the first facet, a second recommendation but not the first recommendation, and a second annotation but not the first annotation.

4. The method of claim 1, comprising:
identifying a role of the first participant and a role of the second participant, selecting a first facet of the application based on the identified role of the first participant, and selecting a second facet based on the identified role of the second participant; and
wherein associating comprises associating the collaborative experience with the first element, the first element including the first facet but not the second facet, and associating the collaborative experience with the second element, the second element including the second facet but not the first facet.

5. The method of claim 1, comprising:
identifying a prior interaction of the first participant and the application and a prior interaction of the second participant with the application, selecting a first facet of the application based on the identified interaction of the first participant, and selecting a second facet based on the identified interaction of the second participant; and
wherein associating comprises associating the collaborative experience with the first element, the first element including the first facet but not the second facet, and associating the collaborative experience with the second element, the second element including the second facet but not the first facet.

6. A system, comprising a computer readable resource having instructions that when executed cause a processing resource to implement a collaboration engine, a personalization engine, and a display engine wherein:
the collaboration engine is configured maintain an experience timeline for a collaborative experience between a first participant and a second participant, the collaborative experience related to an application;
the personalization engine is configured to identify a first element corresponding to the first participant and a second element corresponding to the second participant, the second element differing from the first element;
the display engine is configured to cause a display of first collaboration content for the first participant and second collaboration content for the second participant, the first collaboration content including the experience timeline and the first element but not the second element, and the second collaboration content including the experience timeline and the second element but not the first element.

7. The system of claim 6, wherein the personalization engine is configured to:
identify the first element based on one or more of a role of the first participant and a past interaction of the first participant with one or more of the collaboration engine and the application; and
identify the second element based on one or more of a role of the second participant and a past interaction of the second participant with one or more of the collaboration engine and the application.

8. The system of claim 7, wherein:
the first element includes one or more of a first facet of the application, a first recommendation, and a first annotation; and
the second element includes one or more of a second facet of the application but not the first facet, a second recommendation but not the first recommendation, and a second annotation but not the first annotation.

9. The system of claim 6, wherein the personalization engine is configured to select a first facet of the application personalized for the first participant and select a second facet of the application personalized for the second participant such that:
the identified first element includes the first facet but not the second facet; and
the identified second element includes the second facet but not the first facet.

10. The system of claim 6, further comprising the processing resource.

11. A system, comprising:
a collaboration engine to access data representing a collaborative experience between a first participant and a second participant, the collaborative experience associated with an application;
a personalization engine to identify a first element corresponding to the first participant and a second element corresponding to the second participant, the second element differing from the first element;
a display engine to use the data to cause a display of an experience timeline for the collaborative experience along with the first element but not the second element for the first participant and the experience timeline along with the second element but not the first element for the second participant.

12. The system of claim 11, wherein the personalization engine is configured to:
identify the first element based on one or more of a role of the first participant and a past interaction of the first participant with one or more of the data and the application; and
identify the second element based on one or more of a role of the second participant and a past interaction of the second participant with one or more of the data and the application.

13. The system of claim 12, wherein:
the first element includes one or more of a first facet of the application, a first recommendation, and a first annotation; and
the second element includes one or more of a second facet of the application but not the first facet, a second recommendation but not the first recommendation, and a second annotation but not the first annotation.

14. The system of claim 11, wherein the personalization engine is configured to select a first facet of the application personalized for the first participant and select a second facet of the application facet personalized for the second participant such that:
the identified first element includes the first facet but not the second facet; and
the identified second element includes the second facet but not the first facet.

15. The system of claim 11, wherein the personalization engine is configured to select one or more of a first recommendation and a first experience annotation personalized for the first participant and select one or more of a second recommendation and a second conversation annotation personalized for the second participant such that:
the identified first element includes one or more of the first recommendation and the first conversation annotation but not the second recommendation or the second conversation annotation the second facet; and
the identified second element includes one or more of the second recommendation and the second conversation annotation but not the first recommendation or the first conversation annotation.
